(19) United States
(12) Patent Application Publication
(10) Pub. No.: US 2008/0129823 A1
(43) Pub. Date: Jun. 5, 2008

(54) Video surveillance system and method

(75) Inventors: Alan J. Squillante, Kings Park, NY (US); Peter Kobsa, Floral Park, NY (US); Christopher J. Miller, Central Islip, NY (US)

Correspondence Address: BODNER & O'ROURKE, LLP, 425 BROADHOLLOW ROAD, SUITE 108, MELVILLE, NY, 11747, US

(73) Assignee: Porta Systems Corporation, Syosset, NY (US)

(21) Appl. No.: 11/974,102

(22) Filed: Oct. 11, 2007

Related U.S. Application Data
(60) Provisional application No. 60/851,169, filed on Oct. 12, 2006.

(51) Int. Cl. H04N 7/18

(52) U.S. Cl. 348/143; 348/E07.085

(57) ABSTRACT

A video surveillance system includes a first combiner, and a monitor, a power source and a camera control unit, each of which is electrically coupled to the first combiner. A regulated combiner located remotely from the first combiner and being electrically connected to the first combiner with at least one twisted pair of wires includes a voltage regulator which provides a regulated voltage to the camera located remotely from the first combiner. The camera is operable at a predetermined voltage level. The power supply provides an increased voltage to the regulated combiner through the first combiner and the twisted pair of wires to compensate for IR losses in the twisted pair of wires. Thus, the regulated combiner reduces the increased voltage to a safe level for the CCTV camera and other devices on a network to operate properly. The system dramatically increases the distance that a power supply can be located from where the camera is located, which decreases installation costs for CCTV surveillance systems.

### CROSS REFERENCE TO RELATED APPLICATION

This application is related to U.S. Provisional Application Ser. No. 60/851,169 filed on Oct. 12, 2006, and entitled “Regulated Combiner”, the disclosure of which is incorporated herein by reference and on which priority is hereby claimed.

### BACKGROUND OF THE INVENTION

1. Field of the Invention

This invention relates to transmission equipment for CCTV (closed circuit television) surveillance applications.

2. Description of the Prior Art

There are various solutions for supplying power and control to remote CCTV cameras while transmitting video to receiving, displaying, and or recording equipment which can include VCR's, DVR's, multiplexers, and monitors. One typical configuration of a video surveillance system is to locate a joystick for camera control, a power supply for the camera, and a monitor in close proximity to each other. The camera which transmits video back to the monitor is located away from the other equipment. The camera is powered by the power supply located in close proximity to the monitor. The joystick is located in close proximity to the monitor and controls camera functions such a pan, tilt and zoom (PTZ).

In the current art, an economical way to configure this type of system is shown in FIG. 1. The power, control, and video are combined onto a single cable having four pairs of wires. Category 5, 5e, and 6 unshielded twisted pair (UTP) cable is often used for this application. The power is often carried by two of the pairs and the control by another pair. In some applications, there is a four wire control bus, so the power is carried by one pair and the control uses two pairs. The video is carried by the remaining pair. A balun is typically used within the combiner to convert the unbalanced coax video signal to a balanced twisted pair signal and vice versa at the other end.

The disadvantage of the current art described above is that the distance between the power supply and the camera is limited due to the voltage drop in the UTP cable because of the current resistance (IR) drop in the wire due to the small wire gage used in standard UTP cable.

### OBJECTS AND SUMMARY OF THE INVENTION

It is an object of the present invention to provide a system and method for powering remotely-located electronic devices, including but not limited to surveillance cameras, over long distances using standard twisted pair cable.

It is another object of the present invention to provide a system and method for powering remotely-located cameras which protect the camera in overvoltage or power surge situations.

It is yet a further object of the present invention to provide a system and method for powering remotely-located surveillance cameras using twisted pair cabling which overcome the inherent disadvantages of conventional systems and methods for powering such cameras.

The present invention increases the maximum distance between the power supply and the camera. In the preferred embodiment, the maximum distance between the power supply and the camera is increased by increasing the voltage of the power supply. To prevent overdriving the camera with excess voltage, a voltage regulator is added to the combiner closest to the camera. As a safety backup, an overvoltage protection device may be added to the combiner. Another embodiment of the present invention does not include the backup overvoltage protection device, but may include a surge protection device. This same system can be used for other controllable devices installed in structured wiring systems that require location of power remote from the power supply.

In one form of the present invention, a system for providing a power signal to an electronic device which is located remotely from a source of power includes a first combiner, and the source of power which is electrically coupled to the first combiner. The power source generates a power signal for powering the electronic device. The system may further include a control unit that is electrically coupled to the first combiner, the control unit generating a control signal for the remotely located electronic device.

The system further includes a regulated combiner located remotely from the first combiner and being electrically connected thereto with at least one twisted pair of wires. The system further includes the electronic device which is located remotely from the first combiner and which is electrically coupled to the regulated combiner. The electronic device is operable at a predetermined power level.

The power signal provided by the source of power to the first combiner is greater in magnitude than the predetermined power level at which the electronic device is operable. The first combiner provides the greater magnitude power signal to the regulated combiner over the at least one twisted pair of wires.

The regulated combiner includes a power regulator, such as a voltage regulator, which is responsive to the greater magnitude power signal. The power regulator of the regulated combiner reduces the magnitude of the greater magnitude power signal to at least the predetermined power level at which the camera is operable, and thereby generates a reduced greater magnitude power signal. The regulated combiner supplies the reduced greater magnitude power signal to the camera. The power regulator may be a DC to DC (direct current to direct current) converter, or a DC to AC (direct current to alternating current) converter, the converters either stepping down or stepping up the voltage, or power, provided to the regulated combiner over the twisted pair of wires.

Preferably, the source of power is a voltage source, and the power signal is a voltage which is supplied to the remotely-located electronic device. Even more preferably, the power regulator within the regulated combiner is a voltage regulator which is responsive to the power source (i.e., the voltage provided to the regulated combiner from the first combiner over the at least one twisted pair of wires).

Furthermore, preferably, the electronic device is a closed circuit television camera which is operable at a predetermined voltage level. The voltage provided by the voltage source to the first combiner is greater in magnitude than the predetermined voltage level at which the camera is operable. The first combiner provides the greater magnitude voltage to the regulated combiner over the at least one twisted pair of wires. The regulated combiner, as mentioned previously, includes a voltage regulator that is responsive to the greater magnitude voltage provided over the at least one twisted pair of wires, and the voltage regulator of the regulated combiner reduces the magnitude of the greater magnitude voltage to at least the predetermined voltage level at which the camera is operable, and thereby generates a reduced greater magnitude voltage. The regulated combiner supplies the reduced greater magnitude voltage to the camera, or other electronic device.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a block diagram of a conventional system and method of using combiners to provide power, control, and video over a four pair UTP cable.

FIG. 2 is a block diagram of an improved system and method of the present invention using combiners to provide power, control, and video over a four pair UTP cable, where at least one of the combiners is a regulated combiner.

FIG. 3 is a block diagram of the regulated combiner of the present invention.

FIG. 4 is a block diagram of the regulated combiner with an overvoltage element added in accordance with the present invention to prevent overdriving the camera if the regulator fails.

FIG. 5 is a block diagram of the regulated combiner with surge protection constructed in accordance with the present invention.

FIG. 6 is a block diagram of the regulated combiner with an overvoltage element added in accordance with the present invention to prevent overdriving the camera if the regulator fails, and surge protection.

### DETAILED DESCRIPTION OF THE PREFERRED EMBODIMENTS

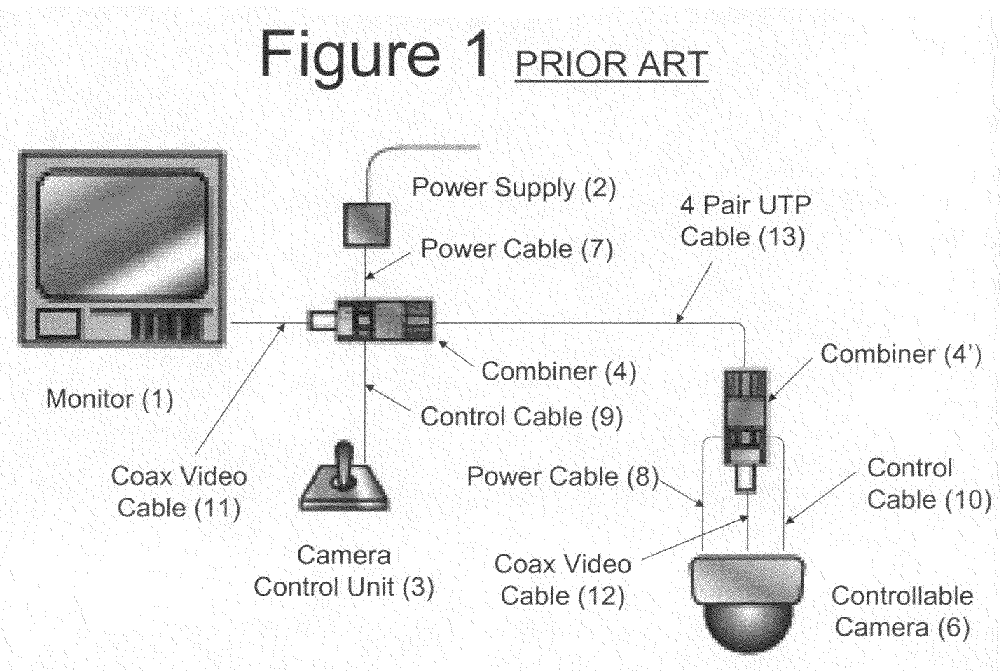

The method used for this invention is an improvement to the current state of the art shown in the system block diagram of FIG. 1. As shown in FIG. 1, the monitor (1) of the conventional surveillance system is connected to the combiner (4) using a coax cable (11). The power supply (2) is connected to the combiner (4) using a power cable (7) or hookup wires. The camera control unit (3) is connected to the first combiner (4) using control cable (9) or hookup wires. The combiner is then connected to a cable (13) which connects to the other combiner (4′) which is located close to the camera (6). The cable (13) is typically a four pair UTP cable meeting the category 5, 5e, or 6 performance specifications, but the cable may be any other suitable cable. The second combiner (4′) is identical to the first combiner (4) in the current state of the art. Exiting the second combiner (4′) are the power cable (8), the control cable (10), and the coaxial video cable (12).

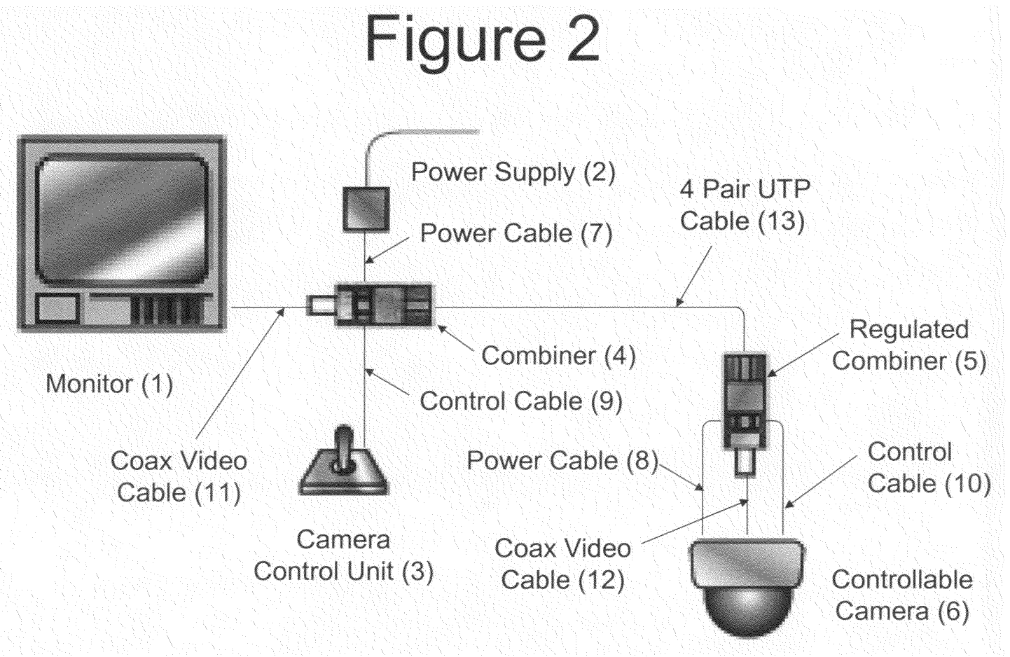

Referring now to FIG. 2 of the drawings, a surveillance system constructed in accordance with the present invention for powering one or more remotely-located cameras is shown and will now be described in detail. The system of the present invention includes all of the structure of the conventional system shown in FIG. 1, except that the second combiner (4′) is replaced by a regulated combiner (5). Components used in the system of the present invention shown in FIG. 2 which have the same or similar structure to those components shown in the conventional system shown in FIG. 1 are designated by the same reference numbers which are used in FIG. 1.

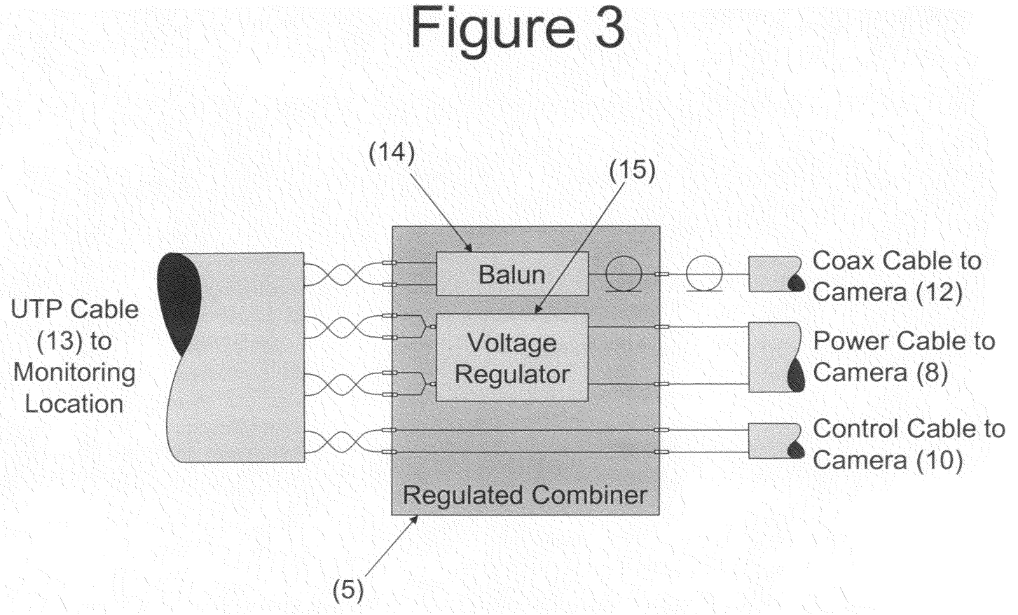

FIG. 2 shows where the regulated combiner (5) is inserted into the system of the present invention. The monitor (1) is connected to the combiner (4) using a coax cable (11). The power supply (2) is connected to the combiner (4) using a power cable (7) or hookup wires, and may provide a DC (direct current) or an AC (alternating current) voltage, or more generally, power to the first combiner (4). Alternatively, the power supply (2) may be formed as an integral part of the first combiner (4). Preferably, the power supply has an output voltage above the required voltage at the camera plus the maximum IR (current times resistance) loss of the longest length of cable (13) permitted in the system. The camera control unit (3) is connected to the combiner (4) using control cable (9) or hookup wires. The combiner (4) is then connected to a cable (13) which connects to the regulated combiner (5) which is located close to the camera (6). The cable (13) is typically a four pair UTP cable meeting the category 5, 5e, or 6 performance specifications, but the cable may be any other suitable cable. The regulated combiner (5) is different from the first combiner (4) (or the second combiner (4′) of the conventional system shown in FIG. 1) due to the addition of a voltage regulator (15), which is broadly defined herein, as shown in FIG. 3. In one form of the present invention, the regulator (15) is designed to lower the voltage to the camera (6) when the length of the cable (13) is less than the maximum length which will prevent overdriving the camera (6). However, the regulator (15), as defined herein, may be or include a DC to DC converter or a DC to AC converter, each of which either steps up or steps down the voltage received at the regulated combiner (5) over the at least one twisted pair of wires, to make the voltage compatible to that required to operate the camera (6) or any other peripheral electronic device located remotely from the first combiner (4), such as a 24 volt AC (alternating current) or 12 volt DC (direct current) voltage, or to provide some other power requirement for the camera (6) or other electronic device. Exiting the regulated combiner (5) are the power cable (8), the control cable (10), and the coaxial video cable (12).

A block diagram of the regulated combiner (5) of the present invention is shown in FIG. 3. The UTP cable (13) is shown connected to one side of the regulated combiner (5). Exiting the regulated combiner (5) are the power cable (8), the control cable (10), and the coax video cable (12). Within the combiner are a balun (14) and the voltage regulator (15). Baluns are used in the current art to convert the signal from unbalanced coax to balanced twisted pair. The voltage regulator advances the state of the art for combiners by allowing the power supply (2) to overdrive the cable (13) without overdriving the camera (6). If necessary, the voltage regulator (15) will step up a lower than needed voltage provided to the regulated combiner (5) due to the voltage drop in the twisted pair of wires of cable (13) to that required by the camera (6) or other electronic device, or convert a DC voltage supplied by the first combiner (4) and the power supply (2) over the twisted pair of wires to an AC voltage, or more generally, power, as required by the camera (6) or other electronic device.

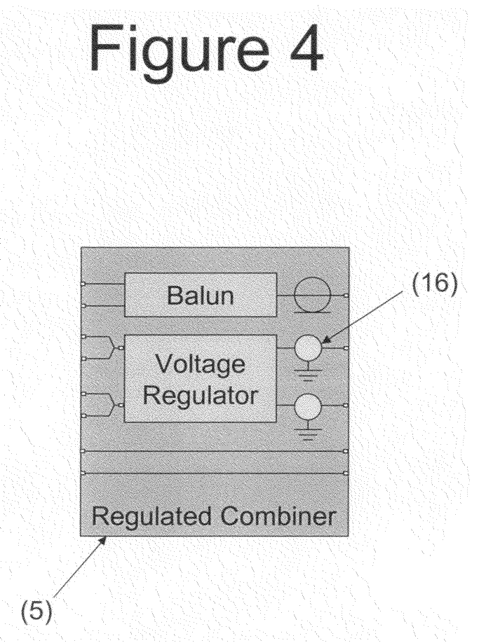

Additional embodiments to the regulated combiner (5) of the present invention are shown in FIGS. 4, 5, and 6. FIG. 4 shows the addition of one or more overvoltage devices (16) electrically coupled between the outputs of the voltage regulator (15) and the power cable (8) connected to the camera. The overvoltage device (16) is provided to prevent overdriving the camera (6) if the voltage regulator fails. Such an overvoltage device (16) may include, but is not limited to, a voltage clamp known in the industry as a Zener diode or a crow-bar device known in the industry as a Thyristor.

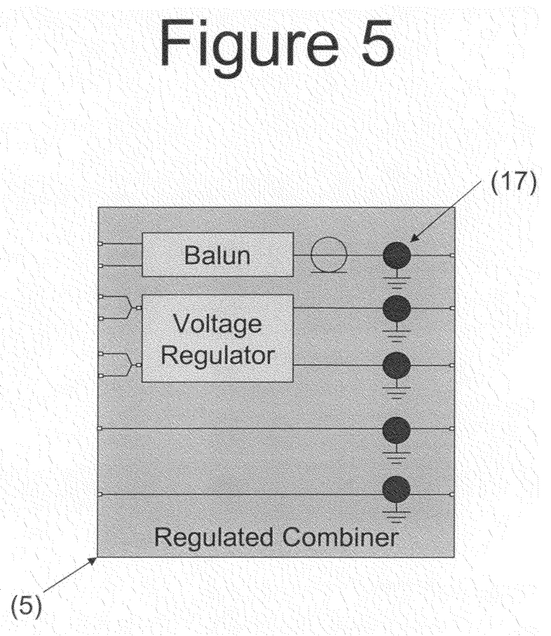

FIG. 5 shows the a regulated combiner (5) with the addition of one or more surge suppression devices (17) preferably electrically coupled between one or more of the outputs of the balun (14) and the coaxial cable (12) connected to the camera, the outputs of the voltage regulator (15) and the power cable (8) connected to the camera, and the control signal twisted pair of wires of cable (13) and the control cable (10) connected to the camera. The surge suppression device (17) is provided to prevent damage to the camera (6) due to a voltage surge. Such a surge suppression device (17) may include, but is not limited to, a Gas Discharge Tube (GDT) or a Transient Voltage Suppressor (TVS).

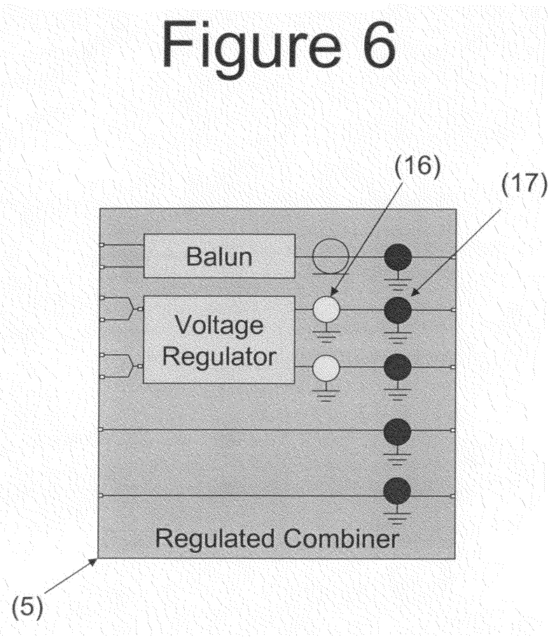

FIG. 6 shows a regulated combiner (5) of the present invention with the addition of both one or more overvoltage devices (16), such as described previously, to prevent overdriving the camera (6) if the voltage regulator fails, and one or more surge suppression devices (17), such as described previously, to prevent damage to the camera (6) due to a voltage surge. The surge suppression devices (17) would be situated in the regulated combiner (5) and electrically connected as described previously with respect to the embodiment of the regulated combiner (5) shown in FIG. 5, and the overvoltage devices (16) would be situated in the regulated combiner (5) and electrically connected to the outputs of the voltage regulator (15) as described previously with respect to the embodiment of the regulated combiner (5) shown in FIG. 4. As can be seen from FIG. 6, the overvoltage devices (16) are electrically connected in series with respective surge suppression devices (17), and the positioning of the overvoltage devices (16) and the surge suppression devices (17), between the outputs of the voltage regulator (15) and the power cable (8) connected to the camera, may be reversed.

The system and method of the present invention allows the surveillance camera, or other electronic device, to be placed at an even greater distance than what was thought possible with conventional systems and methods such as shown in FIG. 1 of the drawings. By increasing the voltage of the power signal at the first combiner (4) to a greater voltage than that which is conventionally used in such surveillance systems, and then regulating the voltage down (or, if necessary, increasing the voltage to compensate for the voltage drop over the length of cable (13)) to that required by the camera at the regulated combiner (5), greater distances between the monitoring and control station and the remotely-located camera can be achieved.

Although a surveillance camera system of the present invention is described previously, it should be understood that the invention is not limited to such surveillance systems, and is applicable to all systems in which an electronic device is located remotely from a source of power, the electronic device being operable at a predetermined power level. Such system would include a first combiner (4), a source of power (2) electrically coupled to the first combiner (4), the source of power generating a power signal for powering the electronic device, which could be the camera (6) described previously, and providing the power signal to the first combiner (4). The system would further include a regulated combiner (5) which is located remotely from the first combiner (4) and which is connected thereto with at least one twisted pair of wires (13).

The electronic device located remotely from the first combiner (4) and electrically coupled to the regulated combiner (5) is operable at a predetermined power level. The power signal provided by the source of power (2) to the first combiner (4) is greater in magnitude than the predetermined power level at which the electronic device is operable. The first combiner (4) provides the greater magnitude power signal to the regulated combiner (5) over the at least one twisted pair of wires (13).

The regulated combiner (5) includes a power regulator, such as the previously described voltage regulator (15), that is responsive to the greater magnitude power signal. The power regulator of the regulated combiner (5) changes the magnitude of the greater magnitude power signal to substantially or to at least the predetermined power level at which the electronic device is operable, thereby generating a reduced greater magnitude power signal. The regulated combiner (5) supplies the reduced greater magnitude power signal to the electronic device.

Furthermore, although the embodiments shown in FIGS. 2-6 of the drawings and the description of the preferred embodiments shown therein relate to a situation where the voltage is increased at the first combiner (4) of the system to compensate for the voltage drop across the length of the twisted pair of wires of cable (13) to the remotely-located regulated combiner (5), and further relate to a situation where a voltage regulator (15) is used in the regulated combiner to regulate the voltage provided by the power supply (2) to the voltage level at which the camera (6) is operable, and further relate to a situation where an overvoltage protection device (16) is used or a surge protection device (17) is used, it should be understood that the system has broader applications than that described and shown in the drawings, and that it is envisioned to be within the scope of the present invention where either voltage or current, or even more generally, power, is controlled by the system. More specifically, the power supply (2) may provide either a greater magnitude voltage or a greater magnitude current (even more generally, a greater magnitude power) than the predetermined power level at which the camera (6) or other electronic device is operable. The regulated combiner (5), instead of merely including a voltage regulator (15), includes a power regulator which regulates the greater magnitude power signal to at least a predetermined power level at which the electronic device is operable. Furthermore, the overvoltage protection devices (16) may more generally be an overpower protection device, and the surge protection devices (17) may prevent power surges (either or both voltage or current, or more generally, power, surges).

Thus, according to the method of the present invention, the distance between a remote CCTV camera (6) and the monitor (1), power supply (2) and control unit (3) for that camera (6), when employing standard category 5, 5e and 6 cable for the transmission of video, power and control signals is increased over conventional methods. The regulated combiner (6) for a remotely-located CCTV camera (6), when mounted a relatively long distance from the monitor (1), power supply (2) and control unit (3) for that camera (6), when employing standard category 5, 5e and 6 cable for the transmission of video, power and control signals, is used in the system of the present invention. The power supply voltage is increased to allow for an increase in the IR (current times resistance) losses in the UTP cable (13) to assure that the voltage input to the camera (6) is not greater than what is designated as the maximum input voltage for the camera (6).

Furthermore, the regulated combiner (5) for the remotely-located CCTV camera (6) may preferably include one or more overvoltage elements (16) to assure that the voltage provided to the camera (6) is not greater than that which is designated as the maximum input voltage for the camera (6) if the voltage regulator (15) of the regulated combiner (5) fails.

Furthermore, the regulated combiner (5) of the system may include one or more overvoltage surge protection devices (17) on one or more of the control, power and video signal wires of the twisted pairs of wires of the cable (13).

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A video surveillance system, which comprises:
a first combiner;
a monitor electrically coupled to the first combiner;
a power source electrically coupled to the first combiner, the power source generating a power signal and providing the power signal to the first combiner;
a camera control unit electrically coupled to the first combiner, the camera control unit generating a camera control signal and providing the camera control signal to the first combiner;
a regulated combiner located remotely from the first combiner and being connected thereto with at least one twisted pair of wires; and
a camera located remotely from the first combiner and electrically coupled to the regulated combiner, the camera being operable at a predetermined power level;
wherein the power signal provided by the source of power to the first combiner is greater in magnitude than the predetermined power level at which the camera is operable, the first combiner providing the greater magnitude power signal to the regulated combiner over the at least one twisted pair of wires; and
wherein the regulated combiner includes a power regulator responsive to the greater magnitude power signal, the power regulator of the regulated combiner changing the magnitude of the greater magnitude power signal to at least substantially the predetermined power level at which the camera is operable, thereby generating a reduced greater magnitude power signal, the regulated combiner supplying the reduced greater magnitude power signal to the camera.

2. A video surveillance system as defined by claim 1, wherein the remotely-located regulated combiner includes at least one overvoltage device, the at least one overvoltage device being electrically coupled to the power regulator and being responsive to at least one of the greater magnitude power signal and the reduced greater magnitude power signal to provide overvoltage protection to the camera.

3. A video surveillance system as defined by claim 1, wherein the regulated combiner includes at least one surge protection device, the at least one surge protection device being electrically coupled to the power regulator and being responsive to at least one of the greater magnitude power signal and the reduced greater magnitude power signal to provide surge protection to the camera.

4. A system for providing a power signal to an electronic device which is located remotely from a source of power, which comprises:
a first combiner;
the source of power electrically coupled to the first combiner, the source of power generating a power signal for powering the electronic device, the power signal being provided to the first combiner;
a regulated combiner located remotely from the first combiner and being electrically connected thereto with at least one twisted pair of wires; and
the electronic device located remotely from the first combiner and being electrically coupled to the regulated combiner, the electronic device being operable at a predetermined power level;
wherein the power signal provided by the source of power to the first combiner is greater in magnitude than the predetermined power level at which the electronic device is operable, the first combiner providing the greater magnitude power signal to the regulated combiner over the at least one twisted pair of wires; and
wherein the regulated combiner includes a power regulator responsive to the greater magnitude power signal, the power regulator of the regulated combiner changing the magnitude of the greater magnitude power signal to at least substantially the predetermined power level at which the electronic device is operable and thereby generating a reduced greater magnitude power signal, the regulated combiner supplying the reduced greater magnitude power signal to the electronic device.

5. A method of powering a remotely-located electronic device over at least one twisted pair of wires, the at least one twisted pair of wires being electrically connected between a first combiner and a regulated combiner, the first combiner being electrically connected to a source of power which generates a power signal, the electronic device being operable at a predetermined power level, which comprises the steps of:
providing the power signal to the first combiner which is greater in magnitude than the predetermined power level at which the electronic device is operable, the first combiner providing the greater magnitude power signal to the regulated combiner over the at least one pair of twisted wires;
changing the magnitude of the greater magnitude power signal by the regulated combiner to at least substantially the predetermined power level at which the electronic device is operable, thereby generating a reduced greater magnitude power signal; and
supplying the reduced greater magnitude power signal to the electronic device.
